(19) United States
(12) Patent Application Publication
(10) Pub. No.: US 2026/0212608 A1
(43) Pub. Date: Jul. 23, 2026

(54) THREE-DIMENSIONAL MODEL INTENSITY ATTRIBUTION

(71) Applicant: Raytheon Company, Arlington, VA (US)

(72) Inventors: Wyatt D. Sharp, Garland, TX (US); Jody D. Verret, Rockwall, TX (US); Corey J. Collard, Plano, TX (US); Kathryn A. Welin, Arlington, VA (US)

(21) Appl. No.: 19/451,919

(22) Filed: Jan. 16, 2026

Related U.S. Application Data
(60) Provisional application No. 63/747,257, filed on Jan. 20, 2025.

(51) Int. Cl. G06T 19/00; G06T 7/33

(52) U.S. Cl. CPC G06T 19/00; G06T 7/344

(57) ABSTRACT

Systems, devices, methods, and computer-readable media for improved image registration to a 3D model are provided. A method can include first registering a first image that includes first intensities associated with a first condition to a three-dimensional (3D) model associated with second intensities of a second, different condition resulting in a registered synthetic image that includes registered third intensities associated with the first condition, adding the registered third intensities to the 3D model so that each location of the 3D model is associated with location coordinates, the first intensities, and the registered third intensities resulting in an augmented 3D model, and second registering, using the location and the registered third intensities, a second image to the augmented 3D model, the second image including fourth intensities associated with the first condition.

### RELATED APPLICATION

This application claims a benefit of priority to U.S. Provisional Patent Application No. 63/747,257, titled “THREE-DIMENSIONAL MODEL INTENSITY ATTRIBUTION” and filed on Jan. 20, 2025, which is incorporated herein by reference in its entirety.

### TECHNICAL FIELD

Aspects regard developing and/or using three-dimensional model database intensity data that is geospatially accurate.

### BACKGROUND

Many three-dimensional models (e.g., 3D point clouds, digital surface models [DSM], mesh, and the like) have intensity attributes from a given data collection system. The intensity attributes are often from a single sensor type and each 3D location has intensity values associated therewith. For example, if a visible-spectrum sensor was used to generate the 3D model, each location in the model can be attributed with red, green, and blue (RGB) values (3 intensity “channels”) for each 3D location.

### BRIEF DESCRIPTION OF DRAWINGS

FIG. 1 illustrates, by way of example, a flow diagram of a technique showing issues with current multi-phenomenology data.

FIG. 2 illustrates, by way of example, a flow diagram of an embodiment of a method for 2D image registration to a 3D model.

FIG. 3 illustrates, by way of example, a synthetic image generated based on EO intensity data.

FIG. 4 illustrates, by way of example, a real EO image of the same geographic region as the synthetic image illustrated in FIG. 3.

FIG. 5 illustrates, by way of example, another synthetic image generated based on EO intensity data.

FIG. 6 illustrates, by way of example, a real image generated using a SAR sensor.

FIG. 7 illustrates, by way of example, a registration method for registering an image associated with a first condition to a 3D model associated with a second, different condition and attributing the 3D model with intensities from the image.

FIG. 8 illustrates, by way of example, a registration method that leverages intensities from the 3D model that is produced from the method of FIG. 7 to register another image associated with the first condition to the 3D model.

FIG. 9 illustrates, by way of example, another synthetic image generated based on SAR intensity data.

FIG. 10 illustrates, by way of example, a real image generated using a SAR sensor.

FIG. 11 illustrates, by way of example, a diagram of an embodiment of a method for improved image registration to a 3D model.

FIG. 12 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Many commercial industries desire and benefit from accurate geospatial intelligence (GEOINT) information. Accurate GEOINT information includes a precise location in space and time for sensing phenomenologies.

Sensors with different “phenomenologies” (e.g., different parts of the electromagnetic spectrum) or “conditions” (e.g., collected at different times of day, different times of year, during different precipitation, light, or other weather conditions, or the like) can also be attributed (“added”) to the 3D model data with additional intensity channels (e.g., an infrared (IR) sensor, a synthetic aperture radar (SAR) sensor). However, attribution of additional intensity channels from additional sensors is of limited utility if the sensor data is not well registered (aligned) with the 3D model.

Embodiments improve multi-phenomenology image registration (e.g., in the form of a registration service) across disparate sensing types and platforms (e.g., Electro-Optical (EO) panchromatic (PAN) imagery, Synthetic Aperture RADAR Imagery (SAR), Infrared imagery (IR), multispectral imagery (MSI), hyperspectral imagery (HSI)) as well as imagery collected under different imaging conditions (e.g., collected at different times of day, different times of year, during different precipitation, light, or other weather conditions, or the like).

An advantage of having several different-phenomenology and scene condition images registered to a same foundational 3D model includes the images themselves accurately geolocated to the 3D model, but it also means that the images themselves are inherently aligned with each other.

Note that “3D” is used herein to specify a visual appearance of the model and does not necessarily mean that exactly three-dimensional units are used to specify a location. Cartesian coordinate systems use three dimensional units to specify a location, but other coordinate systems can represent a location with more or fewer dimensional units. Also, when intensity is added to a Cartesian location, the model is now technically four dimensional but is still referred to as a 3D model because the visual appearance is still 3D.

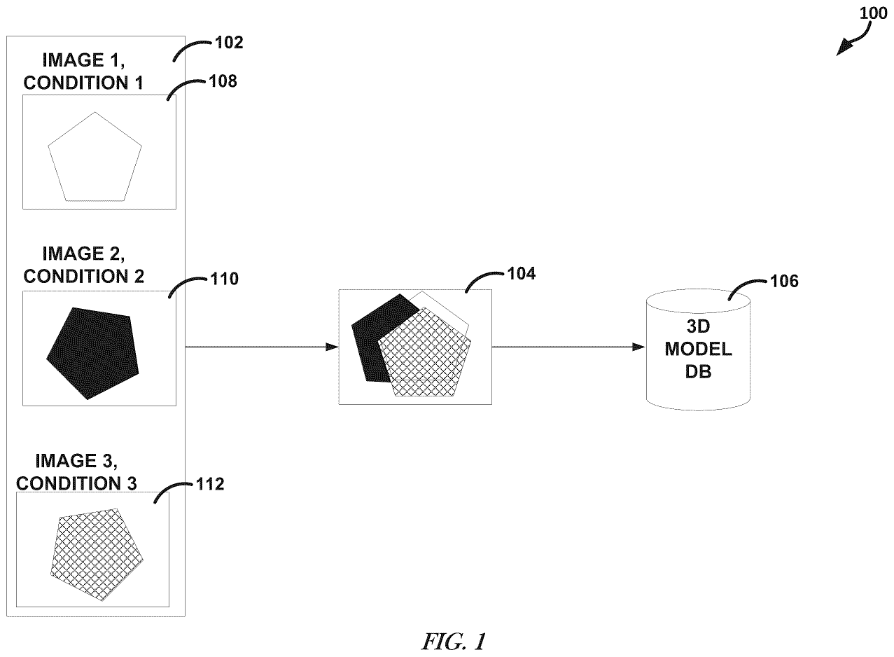

FIG. 1 illustrates, by way of example, a flow diagram of a technique 100 showing issues with current multi-phenomenology data. The technique 100 that is currently used includes geolocating images 102 based on image geometry. For this example, the images 102 are taken at a same geolocation with different sensor types. The images 102 include a first image 108 captured in a first image condition, a second image 110 captured in a second image condition, and a third image 112 captured in a third image condition. Each image condition is different in this example. A different image condition means that the sensor that captured the image is of a different type, or the sensing conditions appreciably changed, such as an illumination has changed by the sun rising or setting. Image types include Electro-Optical (EO) imagery, panchromatic (PAN) imagery, Synthetic Aperture RADAR imagery (SAR), Infrared imagery (IR), multispectral imagery (MSI), hyperspectral imagery (HSI).

The image geometry is provided in metadata of a given image. However, the image geometry in the metadata has geolocation error. Thus, when the images 102 are illustrated concurrently at their location as indicated by the metadata, an object in the images will appear at different locations as shown in image 104. Adding the intensity data from the image types to a 3D location database 106 has limited utility because of the inaccuracy in the geolocation data.

The utility of the images 102 captured in different conditions is much greater when the images 102 are all registered to the same 3D data 106. With accurate registration, the object in the images would be aligned. The aligned images provide a multitude of multi-image exploitation capabilities (e.g., the same object can be identified and accurately geolocated in multiple images). Derivative products from imagery (e.g., artificial intelligence and/or machine learning algorithms for automatic identification of features like an aircraft) also benefit from the accurate registration, providing a database with increased utility.

Embodiments provide an improvement for reliable, robust and automated cross-phenomenology (different condition) registration. Namely, if an accurate cross phenomenology registration can be obtained for a first image, the first image can be used for additional “attribution” of the 3D model data. Subsequent images of the similar phenomenology can then be registered using the same phenomenology “attributes” from the 3D model, thus providing a much more robust registration process. “Similar” phenomenology refers to images whose wavelengths in the electromagnetic spectrum are “close enough” to provide a wealth of similar looking features (e.g., an EO PAN image and the green band from a MSI image) as well as illumination conditions if illumination is a factor in generating the image (e.g., sunlight condition for generating a visible image). The challenges of multi-phenomenology registration (and solutions for robust automation) are discussed below.

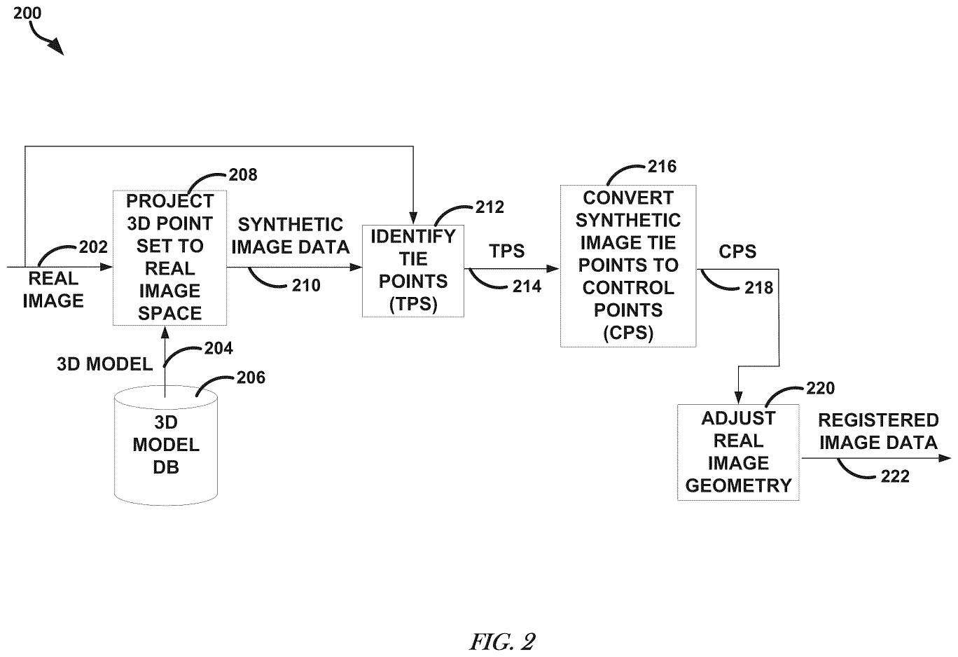

FIG. 2 illustrates, by way of example, a flow diagram of an embodiment of a method 200 for 2D image registration to a 3D location set. The method 200 presents a “classical” image-to-3D model registration algorithm but other registration techniques are possible.

In summary, the method 200 includes, using the geometry metadata of a real image 202, 3D model 204 intensities are projected to the space of the real image 202. This projection process creates a synthetic image 210 derived from the 3D model 204. A real image is one that is generated from a view of the natural world provided by a physical sensor. The real image can be modified from an original form, such as by postprocessing, but is still considered a real image.

Since the geometry metadata very likely has error, the synthetic image 210 will not perfectly align with the real image 202. Tie points (TPs) 214 are thus extracted, at operation 212, between the real image 202 and synthetic image 210, such as by using edge-based image matching (correlation) techniques.

Since the synthetic image 210 TPs 214 have a corresponding 3D location in the model 204, the synthetic image 210 coordinates are converted, at operation 216, to 3D control points (CPs 218) whose coordinates come from the 3D model 204.

The database that supports the 3D model 204 can include corrected image geometry metadata (registered image data 222). The corrected image geometry metadata can be from a series of overlapping geolocated images. Images of varying modalities can be stored and used for updating intensity values of the 3D model 204. Since natural scenes can vary over time of day, time of year, etc. having real registered images for varying timeframes can help better provide a view of the natural world at a given time.

The 3D CP 218 location coordinates and associated real-image TP 214 coordinates are provided to a photogrammetric resection process (also known as a single-image bundle adjustment) that adjusts image geometry at operation 220. The resection process at operation 220 uses the CPs 218 and real image coordinates as observations in a least squares bundle adjustment, which corrects for errors in the real-image geometry metadata.

The end result of the above process is registered image data 222 that includes real image data that is accurately registered to the 3D model 204. The process can be repeated for a second, third, fourth (etc.) real image. Since the first, second, third (etc.) real images are accurately registered to the same foundational 3D model, then the images themselves are accurately registered providing for rich “multi-phenomenology layering”.

The method 200 includes receiving real image 202 and a 3D model 204 (a subset of a 3D dataset 206 that corresponds to a geographic region). The image 202 can be from a SAR, EO, panchromatic, IR, MSI, nighttime EO, visible, nighttime visible, or another image sensor. The image sensor may be satellite based, located on a manned or unmanned aerial vehicle, mounted on a moveable or fixed platform, or otherwise positioned in a suitable manner to capture the image 202 of a region of interest. The 3D model 204 can be from a 3D model database (DB) 206. The 3D model 204 can be of a geographical region that overlaps with a geographical region depicted in the image 202. In some embodiments, the 3D model 204 can be of a geographical region that includes the entire geographical region depicted in the image 202. In some embodiments, the 3D model 204 can cover a larger geographical region than the geographical region depicted in the image 202.

The image registration can occur in an overlap in a geographical region covered by both the 3D model 204 and the image 202. The 3D location set data in the overlap (plus an uncertainty region) can be provided as input to operation 208. The overlap can be determined by identifying the minimum (min) and maximum (max) X and Y of the extent of the 3D location set intersected with the min and max X and Y of the image 202, where X and Y are the values on the axes of a geometric coordinate system of the image 202.

The operation 208 can include establishing a scale of the synthetic image data 210 and its geographical extent. The scale can be computed as a location spacing of the 3D model 204 or as a poorer of the location spacing of the 3D model 204 and the X and Y scale of the image 202. The geographical extent of the synthetic image data 210 can be determined by generating an X, Y convex hull of the 3D model 204 and intersecting it with a polygon defined by X, Y coordinates of the extremes of the image 202. The minimum bounding rectangle of this overlap region can define an output space for the synthetic image data 210.

At operation 208, the 3D model 204 is projected to an image space of the image 202 to generate the synthetic image data 210. The image space of the image 202 can be specified in metadata associated with image data of the image 202. The image space can be the geometry of the image, such as a look angle, focal length, orientation, the parameters of a perspective transform, the parameters and coefficients of a rational polynomial projection (e.g., XYZ-to-image and/or image-to-XYZ), or the like. The operation 220 can include altering geometry metadata of a real image 202 to match the geometry of the synthetic image 210 derived from the 3D model 204.

If more than one location from the 3D model 204 projects to a same pixel of the synthetic image data 210, the location from the 3D location set that is closest to the sensor position can be used. This assures that only locations visible in the collection geometry of the image 202 are used in the synthetic image data 210. Locations that project outside the computed geographic overlap (plus some uncertainty region) can be discarded.

Each location in the 3D model 204 can include an X, Y, Z coordinate, elevation, and intensity value(s) (e.g., a grayscale intensity, red, green, blue intensity, or the like). In some embodiments a median of the intensities of the pixels that the location represents in all the images used to generate the 3D model 204 can be used as the color value.

A geometry of an image can be determined based on a location, orientation, focal length of the camera, the parameters of a perspective transform, the parameters and coefficients of a rational polynomial projection (e.g., image-to-XYZ or XYZ-to-image projection or the like), and/or other metadata associated with the imaging operation in the image 202.

The initial synthetic image data 210 may have many pixels that were not filled (called void pixels). Void pixels are created when no location in the 3D model 204 projected to that pixel of the synthetic image data 210. To fill in the void pixels, an interpolation method can be used that first looks for opposite neighbors in a neighborhood of the pixel (pixels contiguous with the pixel or less than a specified number of pixels away from the pixel). An average value (e.g., a mean, median, mode, or other average value) of all such pixels can be used for an intensity value for the uninitialized pixel. If no opposite neighbors exist, the intensity can be set to a mean intensity of all neighbors. If the neighborhood contains no initialized pixels, then a mean intensity of an outer ring or other pixels of a larger neighborhood can be used as the intensity value for the pixel. If the larger neighborhood (e.g., a 5×5 with the pixel at the center) is empty, then the pixel intensity can be set to 0 to indicate it is a void pixel. The interpolation process can be run iteratively to fill in additional void pixels. Void pixels may remain after the interpolation process, but the registration process and further applications are designed to handle such voids.

At operation 212, tie points (TPs) 214 can be identified in the synthetic image data 210. A TP is a four-tuple (row from synthetic image data 210, column from synthetic image data 210, row of the real image 202, column of the real image 202) that indicates a row and column of the image 202 (row, column) that maps to a corresponding row and column of the synthetic image data 210 (row, column).

The operation 212 can include operating an edge-based technique on an image tile to generate an edge pixel template for the synthetic image data 210 to be correlated with the gradient of image 202. An edge pixel template can include a gradient magnitude and phase direction for each edge pixel in an image tile. The edge pixel template can include only high contrast edges (not in or adjacent to a void in the synthetic image data 210). Alternatives to edge-based correlation techniques include fast Fourier transform (FFT), or normalized cross correlation (NCC), among others.

At operation 216, the TPs 214 are converted to CPs 218 using the 3D model 204 from which the synthetic image data 210 was produced. The CPs 218 are five-tuples (row of the image 202, column of the image 202, X, Y, and Z) if the image 202 is being registered to the 3D model 204 (via the synthetic image data 210). The CPs 218 can include an elevation corresponding to a top of a building. A CP 218 corresponds to a location in a scene. The registration provides knowledge of the proper location in the 3D model 204 by identifying the location that corresponds to the location to which the pixel of the real image 202 is registered.

The TPs 214 can be associated with a corresponding closest location in the 3D model 204 to become CPs 218. The TPs 214 can be associated with an error covariance matrix that estimates the accuracy of the registered TP 214. An index of each projected 3D location from the 3D model 204 can be preserved when creating the synthetic image data 210 at operation 208. A nearest 3D location to the center of a tile associated with the TP 214 can be used as a coordinate for the CP 218. The error covariance can be derived from a shape of a registration score surface at a peak, one or more blunder metrics, or a combination thereof.

At operation 220, the geometry of the image 202 can be adjusted by a photogrammetric resection. Photogrammetric resection can include a least squares bundle adjustment or the like to bring the real image 202 into geometric alignment with the 3D model 204. The geometric bundle adjustment can include a nonlinear, least squares adjustment to reduce (e.g., minimize) misalignment between the CPs 218 of the image 202 and the synthetic image data 210.

After the operation 220 converges, the geometry of the image 202 can be updated to match the registered control. As long as the errors of the TPs 214 are uncorrelated, the adjusted geometry is more accurate than the TPs 214 themselves. A registration technique using CPs (e.g., a known XYZ location and a known image location for that location) can be used to perform operation 220. From the CPs 218, the imaging geometry of the image 202 can be updated to match the geometry of the CPs 218.

An example of the operation 220 is now summarized. Image metadata can include an estimate of the sensor location and orientation at the time the image was collected, along with camera parameters, such as focal length. If the metadata was perfectly consistent with the 3D model 204, then every 3D location of the 3D model would project exactly to the correct spot in the image 202. For example, the base of a flagpole in the 3D model 204 would project exactly to where one sees the base of the flagpole in the image 202. But, in reality, there are inaccuracies in the metadata of the image 202. If the estimate of the camera position is off a little, or if the estimated camera orientation is not quite right, then the 3D location representing the base of the flagpole will not project exactly to the pixel of the base in the image 202. But with the adjusted geometry, the base of the flagpole will project very closely to where the base is in the image 202. The result of the registration is adjusted geometry for the image 202. Any registration process can be used that results in an adjusted geometry for the image 202 being consistent with the 3D model 204.

The method 200 works well when the conditions associated with the synthetic image 210 and the real image 202 are similar. For example, if the 3D intensities of the 3D model 204 are from a visible electro-optical (EO) sensor (e.g., panchromatic intensities from commercial satellite images) and the intensities from the real image 202 are also EO panchromatic intensities, then the synthetic image 210 and the real image 202 will look very similar including having similar edge content. As a result, a larger number of successful TPs 214 can be obtained between the synthetic image 210 and the real image 202 than if the synthetic image 210 and the real image 202 are associated with different conditions.

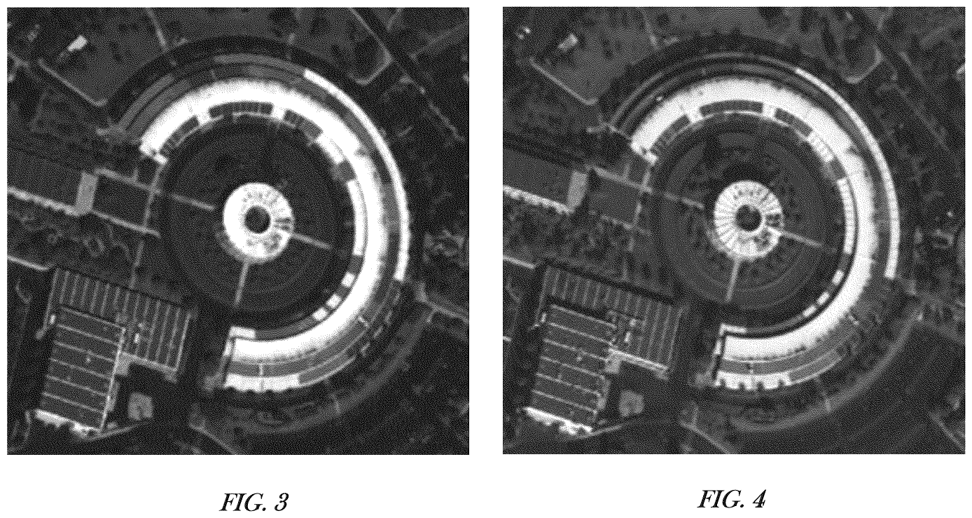

FIG. 3 illustrates, by way of example, a synthetic image 210 generated based on EO intensity data. FIG. 4 illustrates, by way of example, a real EO image 202 of the same geographic region as the synthetic image 210 illustrated in FIG. 3. In FIGS. 3 and 4, the synthetic image 210 and real image 202 features look very similar since the underlying intensity data is from the same phenomenology, EO sensor with daytime illumination. This results in a very large number of TP 214 correspondences between the synthetic image 210 and real image 202, thus providing robustness and accuracy in the registration method 200.

However, there are challenges in the registration method 200 (and other registration methods 200) when the real image 202 comes from a different phenomenology (associated with different conditions) than the intensities stored in the 3D model 204. One example of different conditions includes EO panchromatic intensities in the 3D model 204 with the new real image 202 coming from a SAR sensor).

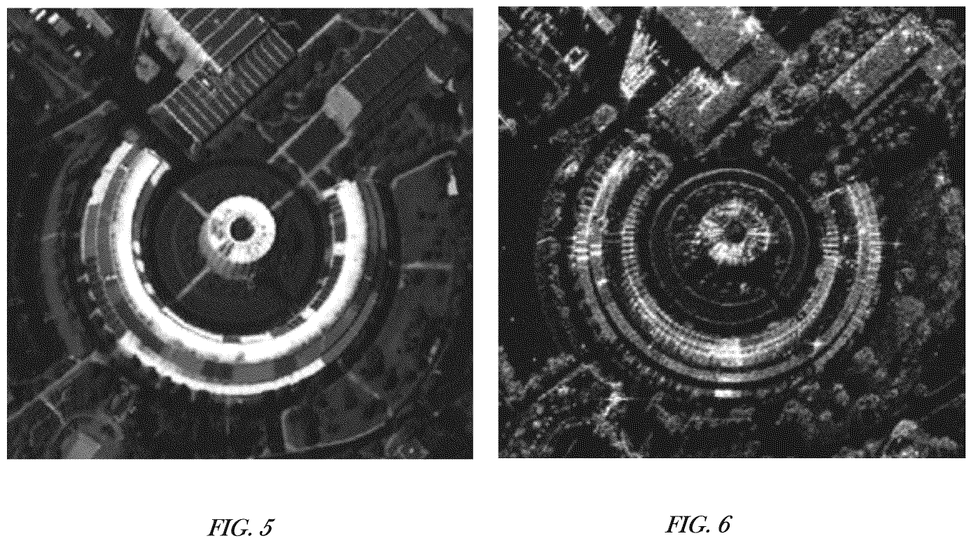

FIG. 5 illustrates, by way of example, another synthetic image 210 generated based on EO intensity data. FIG. 6 illustrates, by way of example, a real image 202 generated using a SAR sensor. As can be seen in FIGS. 5 and 6 the features between the two different images of FIGS. 5 and 6 that are associated with different phenomenologies look quite different. As a result, the number of TPs 214 is often too small to provide accurate registration and thus often results in registration failures. Embodiments provide a robust registration improvement via a process that includes multiple registration operations.

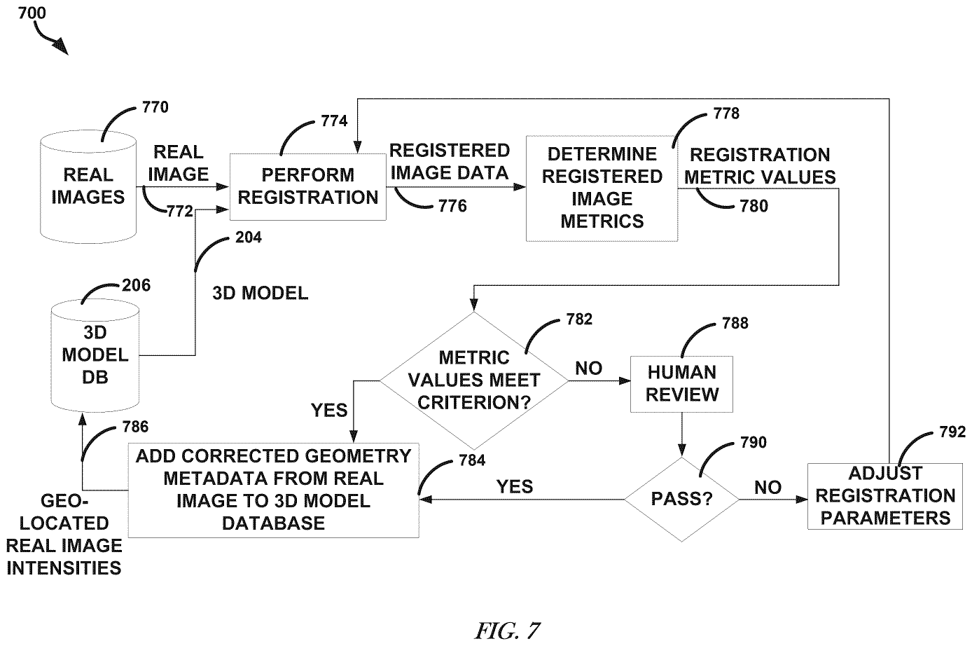

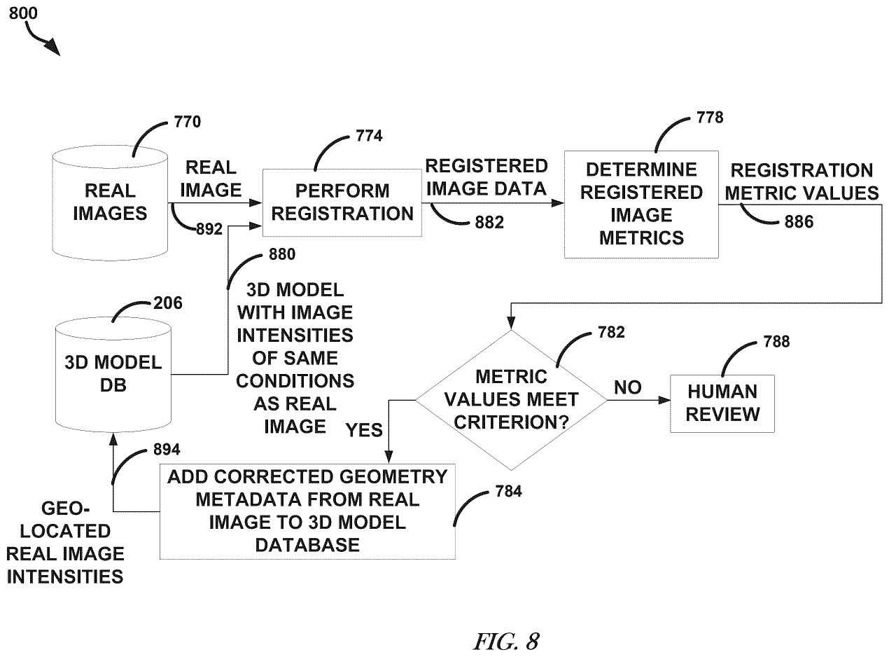

FIG. 7 illustrates, by way of example, a registration method 700 for registering an image associated with a first condition to a 3D model associated with a second, different condition and attributing the 3D model with intensities from the image. FIG. 8 illustrates, by way of example, a registration method 800 that leverages intensities from the 3D model that is produced from the method 700 of FIG. 7 to register another image associated with the first condition to the 3D model. These methods 700, 800 will be described assuming that a real SAR image is captured and is being registered to a 3D model 204 that has EO intensities attributed thereto. However, a SAR image and EO intensities are just example conditions, and many other conditions are possible. The possible conditions include all of the conditions discussed herein as well as others.

In summary, in the methods 700, 800, the registration method 200 is performed upon a first SAR image 772 using EO intensities from the 3D model 204, at operation 774. The synthetic image 776 for registration thus has EO (e.g., panchromatic) intensities, while the real image 772 has SAR intensities.

Post-registration result metrics 780 are (e.g., automatically, such as without human interference after deployment) determined at operation 778. The metrics 780 are automatically evaluated against a criterion (e.g., a threshold, such as can be defined by a subject matter expert (SME)) at operation 782. Some typical registration metrics include the number of CPs 218 obtained by the operation 774 that registers the synthetic EO intensity image and the real first SAR image. A second metric is the photogrammetric post-adjusted Root Mean Square (RMS) of residuals (in units of pixels). If the registration metrics indicate a sufficient registration, the operation 784 is performed. Some example sufficient metric conditions include at least 10 CPs 218 and RMS residuals of one pixel or less. Empirical evidence suggests that 30 CPs 218 and an RSM of residuals less than one pixel provides a sufficiently good registration. Exceptionally good registration is realized with hundreds of CPs 218 and RSM of residuals less than 0.5 pixels. The operation 784 attributes respective intensities 786 from the real image 772 to corresponding 3D model locations in database 206 (e.g., in the 3D model 204). The corresponding 3D locations are obtained by evaluating the adjusted real image 222 geometry metadata obtained from operation 220.

The operation 784 can include adding corrected geometry metadata to the 3D model database 206. The method 700 can include determining a mathematical combination of intensities from multiple real images of a same geographic region. The mathematical combination for a given location can be used for the intensity for the corresponding location in the 3D model 204. The mathematical combination can be a weighted average, for example. Note that some images of a same geographic region can have views of different locations, such as if the images have different view angles. The mathematical combination can be determined after filtering for shadows, clouds, occlusions, or the like.

If the registration metrics 780 are not sufficient (they do not meet the criterion at operation 782), an optional human review, at operation 788, of the post-registration accuracy can be performed. The operation 788 can include examination of the registration metrics and/or a human “flickering” between the synthetic EO image 776 and the real first SAR image 772. If the registration is deemed to be accurate, at operation 790, the method 700 proceeds by performing operation 784. Otherwise, the human reviewer can adjust (or “tune”) the automatic registration algorithm parameters at operation 792. Adjusting the registration parameters can include, for example, increasing the search radius for TPs 214 or CPs 218. The registration can then be performed with the increased search radius at operation 774 and the method 700 can continue from there until the automated registration is deemed to be sufficiently accurate.

Alternatively (if automatic registration for a particular first image fails), a different “first” SAR image is chosen for the registration until sufficient registration metrics are met. The different image may come from a historical imagery archive database 770 or from a sequence of images collected with different viewing geometries. The second alternative may provide a fully automated approach by simply continuing to choose “first” SAR images until registration accuracy metrics are deemed sufficient to indicate a good automatic registration.

With a sufficient first SAR image 772 registration, the post-registration geometry is used to “attribute” the 3D model with the first-image SAR intensities 786 at operation 784. This forms another “intensity channel” within the 3D model 204. It should be noted that the 3D coordinates of the model are not changed—that is, within this step, an additional metadata field (“attribute”) is added to the 3D model data. The additional attribute is the SAR intensities of the first SAR image after sufficient registration.

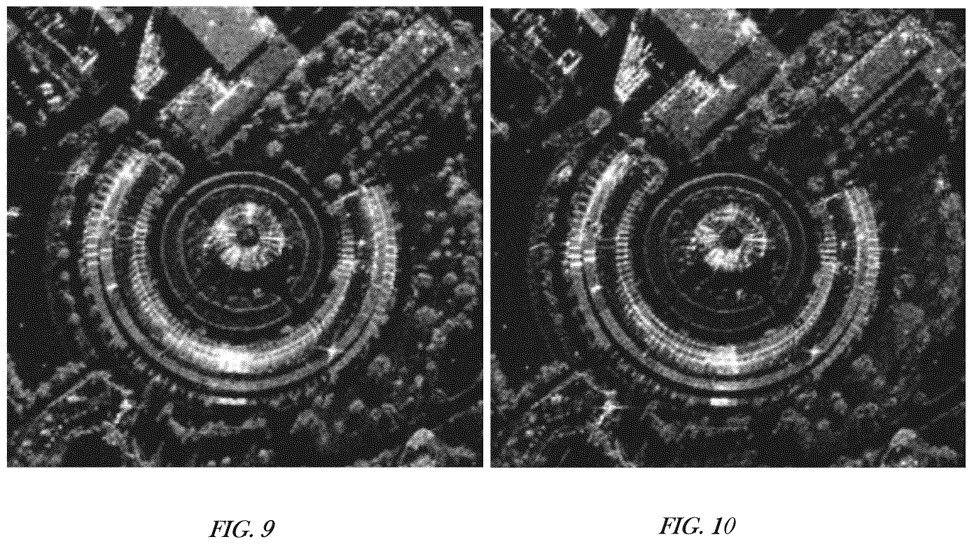

Referring now to FIG. 8, further registration processing, by performing method 800, can then proceed with a subsequent (i.e., second, third, fourth, etc.) real SAR image 892. Using the method 800 the synthetic image 882 formed for the registration, using the operation 774, is based on the (newly attributed) first SAR image intensities 786 from the 3D model 880. Since the synthetic image 882 and second real SAR image 892 have the same “phenomenology”, the number of TPs 214/CPs 218 are increased by an order of magnitude since the synthetic and real image features look very similar (see FIG. 9 and FIG. 10). The second, third, (etc.) real SAR image 892 registrations to the 3D model 880 are thus significantly more accurate and much more highly conducive to automated processing as compared to registration with a 3D model that includes intensities associated with different conditions. This is primarily due to the fact that registration metrics 886 will be improved since the synthetic image 882 and real image 892 are of the same phenomenology. The registration metrics via method 800 can exceed several hundreds of TPs/CPs with RMS of residuals less than 0.5 pixels.

Optionally, using the method 800, the second, third (etc.) registered SAR image intensities 894 are attributed as additional “intensity channels” in the 3D model 880. This provides for a rich set of registered 3D data for downstream analysis and processing (e.g., temporal changes in SAR intensities over time).

FIG. 9 illustrates, by way of example, another synthetic image 882 generated based on SAR intensity data. FIG. 10 illustrates, by way of example, a real image 892 generated using a SAR sensor.

It is clear by comparing FIGS. 9 and 10, that the registration based on SAR intensities from the attributed 3D model 880 for the synthetic image 882 improves the likelihood of a successful registration to the real (second) SAR image 892. This is because features in the synthetic SAR image 882 and real SAR image 892 look very similar. As a result, a larger number of TPs 214 can be found between the two, thus providing significant robustness and accuracy in the registration (as contrasted with the registration illustrated in FIGS. 5 and 6)

It should be noted that the present approach for multi-phenomenology (cross sensor) registration exemplified above is for SAR imagery. However, the same approach will work if the first image for registration to EO intensities from the 3D model is infrared (IR) imagery. One can simply repeat the process, but this time the added 3D model location intensity attributes are from the first IR image registration. A second (third, fourth, etc.) IR image can then be very accurately registered to the 3D model by using the attributed first-IR image intensities from the 3D model when forming the second (third, fourth, etc.) synthetic image to be registered to the second (third, fourth, etc.) real IR image. A similar argument holds for other phenomenologies and imaging conditions (e.g., MSI, HSI, daytime and night-time images, among many others).

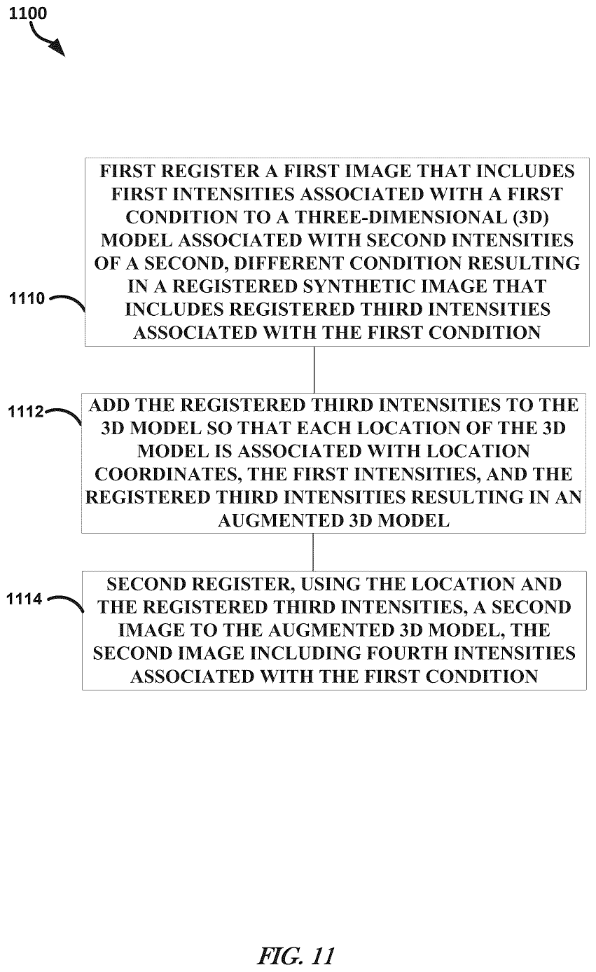

FIG. 11 illustrates, by way of example, a diagram of an embodiment of a method 1100 for improved image registration. The method 1100 as illustrated includes first registering a first image that includes first intensities associated with a first condition to a three-dimensional (3D) model associated with second intensities of a second, different condition resulting in a registered synthetic image that includes registered third intensities associated with the first condition, at operation 1110; adding the registered third intensities to the 3D model so that each location of the 3D model is associated with a location, the first intensities, and the registered third intensities resulting in an augmented 3D model, at operation 1112; and second registering, using the location and the registered third intensities, a second image to the augmented 3D model, the second image including fourth intensities associated with the first condition, at operation 1114.

The first image, second image, and 3D model can depict overlapping geographical regions. The first condition and second, different condition can include respective intensities generated by different respective types of image sensors. The first condition and second, different condition include respective intensities generated by different respective illumination conditions.

The method 1100 can further include before adding the registered third intensities to the 3D model, determining a registration metric value based on the first real image and the registered synthetic image. The method 1100 can further include verifying the registration metric value satisfies a criterion. The operation 1112 can occur only if the registration metric value satisfies the criterion. The method 1100 can further include, responsive to verification failing, adjusting a parameter associated with the first registering and re-performing the first registering with the adjusted parameter.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus (e.g., a programmable processor, a computer, or multiple computers).

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium (e.g., Storage Device)

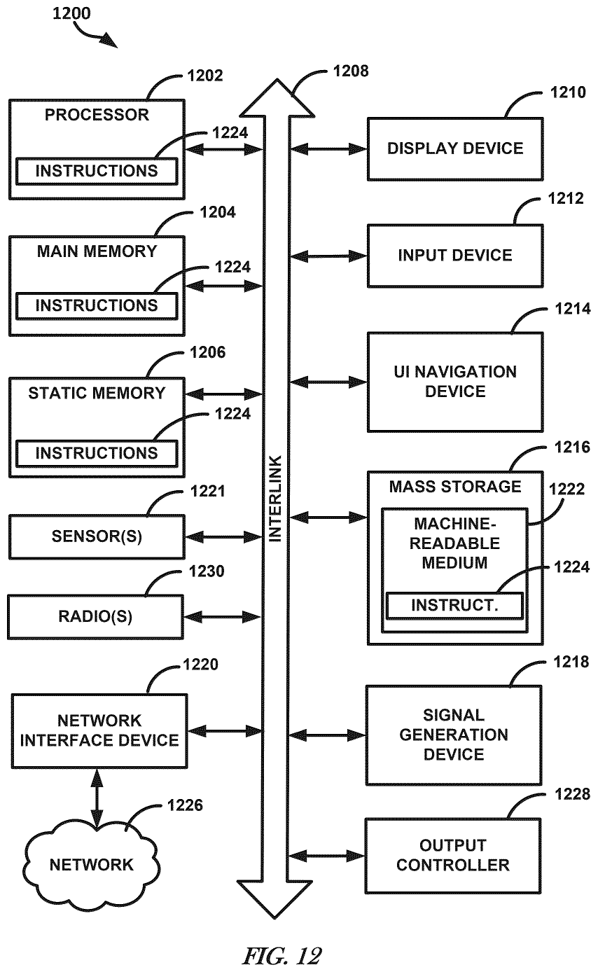

FIG. 12 illustrates, by way of example, a block diagram of an embodiment of a machine in the example form of a computer system 1200 within which instructions, for causing the machine to perform any one or more of the methodologies discussed herein, may be executed. One or more of the methods 200, 700, 800 or an operation thereof can be implemented or performed by the computer system 1200. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., processing circuitry, such as can include a central processing unit (CPU), a graphics processing unit (GPU), field programmable gate array (FPGA), other circuitry, such as one or more transistors, resistors, capacitors, inductors, diodes, regulators, switches, multiplexers, power devices, logic gates (e.g., AND, OR, XOR, negate, etc.), buffers, memory devices, sensors 1221 (e.g., a transducer that converts one form of energy (e.g., light, heat, electrical, mechanical, or other energy) to another form of energy), such as an IR, SAR, SAS, visible, or other image sensor, or the like, or a combination thereof), or the like, or a combination thereof), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device 1214 (e.g., a mouse), a disk drive unit 1216, a signal generation device 1218 (e.g., a speaker), a network interface device 1220, and radios 1230 such as Bluetooth, WWAN, WLAN, and NFC, permitting the application of security controls on such protocols. Note that a space vehicle does not typically include a display, UI navigation device, or the like.

The machine 1200 as illustrated includes an output controller 1228. The output controller 1228 manages data flow to/from the machine 1200. The output controller 1228 is sometimes called a device controller, with software that directly interacts with the output controller 1228 being called a device driver.

### Machine-Readable Medium

The disk drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204, the static memory 1206, and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Additional Example

Example 1 includes a method comprising first registering a first image that includes first intensities associated with a first condition to a three-dimensional (3D) model associated with second intensities of a second, different condition resulting in a registered synthetic image that includes registered third intensities associated with the first condition, adding the registered third intensities to the 3D model so that each location of the 3D model is associated with a location, the first intensities, and the registered third intensities resulting in an augmented 3D model, and second registering, using the location and the registered third intensities, a second image to the augmented 3D model, the second image including fourth intensities associated with the first condition.

In Example 2, Example 1 further includes, wherein the first image, second image, and 3D model depict overlapping geographical regions.

In Example 3, at least one of Examples 1-2 further includes, wherein the first condition and second, different condition include respective intensities generated by different respective types of image sensors.

In Example 4, at least one of Examples 1-3 further includes, wherein the first condition and second, different condition include respective intensities generated by different respective illumination conditions.

In Example 5, at least one of Examples 1-4 further includes before adding the registered third intensities to the 3D model, determining a registration metric value based on the first real image and the registered synthetic image, and verifying the registration metric value satisfies a criterion.

In Example 6, Example 5 further includes, wherein adding the registered third intensities occurs only if the registration metric value satisfies the criterion.

In Example 7, at least one of Examples 5-6 further includes, responsive to verification failing, adjusting a parameter associated with the first registering and re-performing the first registering with the adjusted parameter.

Example 8 includes a system comprising processing circuitry and a memory including instructions that, when executed by the processing circuitry, cause the processing circuitry to perform the method of at least one of one of Examples 1-7

Example 9 includes a non-transitory machine-readable medium including instructions that, when executed by a machine, cause the machine to perform the method of at least one of one of Examples 1-7.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method comprising:
first registering a first image that includes first intensities associated with a first condition to a three-dimensional (3D) model associated with second intensities of a second, different condition resulting in a registered synthetic image that includes registered third intensities associated with the first condition;
adding the registered third intensities to the 3D model so that each location of the 3D model is associated with location coordinates, the first intensities, and the registered third intensities resulting in an augmented 3D model; and
second registering, using the location and the registered third intensities, a second image to the augmented 3D model, the second image including fourth intensities associated with the first condition.

2. The method of claim 1, wherein the first image, second image, and 3D model depict overlapping geographical regions.

3. The method of claim 1, wherein the first condition and second, different condition include respective intensities generated by different respective types of image sensors.

4. The method of claim 1, wherein the first condition and second, different condition include respective intensities generated by different respective illumination conditions.

5. The method of claim 1, further comprising:
before adding the registered third intensities to the 3D model, determining a registration metric value based on the first image and the registered synthetic image; and
verifying the registration metric value satisfies a criterion.

6. The method of claim 5, wherein adding the registered third intensities occurs only if the registration metric value satisfies the criterion.

7. The method of claim 5, further comprising responsive to verification failing, adjusting a parameter associated with the first registering and re-performing the first registering with the adjusted parameter.

8. The method of claim 1, further comprising, storing, for each of the first and second images, corrected image geometry metadata.

9. A system comprising:
processing circuitry;
a memory including instructions that, when executed by the processing circuitry, cause the processing circuitry to perform operations for improved image registration to a three-dimensional (3D) model, the operations comprising:
first registering a first image that includes first intensities associated with a first condition to a three-dimensional (3D) model associated with second intensities of a second, different condition resulting in a registered synthetic image that includes registered third intensities associated with the first condition;
adding the registered third intensities to the 3D model so that each location of the 3D model is associated with location coordinates, the first intensities, and the registered third intensities resulting in an augmented 3D model; and
second registering, using the location and the registered third intensities, a second image to the augmented 3D model, the second image including fourth intensities associated with the first condition.

10. The system of claim 9, wherein the first image, second image, and 3D model depict overlapping geographical regions.

11. The system of claim 9, wherein the first condition and second, different condition include respective intensities generated by different respective types of image sensors.

12. The system of claim 9, wherein the first condition and second, different condition include respective intensities generated by different respective illumination conditions.

13. The system of claim 9, further comprising:
before adding the registered third intensities to the 3D model, determining a registration metric value based on the first image and the registered synthetic image; and
verifying the registration metric value satisfies a criterion.

14. The system of claim 13, wherein adding the registered third intensities occurs only if the registration metric value satisfies the criterion.

15. The system of claim 13, further comprising responsive to verification failing, adjusting a parameter associated with the first registering and re-performing the first registering with the adjusted parameter.

16. A non-transitory machine-readable medium including instructions that, when executed by a machine, cause the machine to perform operations for improved image registration to a three-dimensional (3D) model, the operations comprising:
first registering a first image that includes first intensities associated with a first condition to a three-dimensional (3D) model associated with second intensities of a second, different condition resulting in a registered synthetic image that includes registered third intensities associated with the first condition;
adding the registered third intensities to the 3D model so that each location of the 3D model is associated with location coordinates, the first intensities, and the registered third intensities resulting in an augmented 3D model; and
second registering, using the location and the registered third intensities, a second image to the augmented 3D model, the second image including fourth intensities associated with the first condition.

17. The non-transitory machine-readable medium of claim 16, wherein the first image, second image, and 3D model depict overlapping geographical regions.

18. The non-transitory machine-readable medium of claim 16, wherein the first condition and second, different condition include respective intensities generated by different respective types of image sensors.

19. The non-transitory machine-readable medium of claim 16, wherein the first condition and second, different condition include respective intensities generated by different respective illumination conditions.

20. The non-transitory machine-readable medium of claim 16, wherein the operations further comprise:
before adding the registered third intensities to the 3D model, determining a registration metric value based on the first image and the registered synthetic image; and
verifying the registration metric value satisfies a criterion.
